(19) United States
(12) Patent Application Publication
(10) Pub. No.: US 2020/0393128 A1
(43) Pub. Date: Dec. 17, 2020

(54) VARIABLE GEOMETRY ROTATING DETONATION COMBUSTOR

(71) Applicant: General Electric Company, Schenectady, NY (US)

(72) Inventors: Joseph Zelina, Waynesville, OH (US); Sibtosh Pal, Mason, OH (US); Arthur Wesley Johnson, Cincinnati, OH (US); Clayton Stuart Cooper, Loveland, OH (US); Steven Clayton Vise, Loveland, OH (US)

(21) Appl. No.: 17/004,586

(22) Filed: Aug. 27, 2020

Related U.S. Application Data
(62) Division of application No. 15/618,431, filed on Jun. 9, 2017.

(51) Int. Cl. F23R 3/00; F23R 7/00; F02C 3/16; F23R 3/16; F23R 3/56; F02C 3/14; F23R 3/42

(52) U.S. Cl. CPC F23R 3/002; F23R 7/00; F02C 3/16; F23R 3/50; F23R 3/56; F02C 3/14; F23R 3/42; F23R 3/16

(57) ABSTRACT

A propulsion system defining a longitudinal centerline extended along a longitudinal direction is provided. The propulsion system includes an inlet section configured to provide an oxidizer to a rotating detonation combustion system positioned downstream of the inlet section. The rotating detonation combustion system includes a nozzle assembly positioned to provide a flow mixture of oxidizer and fuel to a combustion chamber, a centerbody forming an inner wall of the combustion chamber, an outer wall at least partially surrounding the centerbody, wherein the inner wall and the outer wall define a volume of the combustion chamber; and an actuation structure coupled to the nozzle assembly. The actuation structure is configured to expand and contract to displace the nozzle assembly along the longitudinal direction to alter the volume of the combustion chamber.

### CROSS-REFERENCE TO RELATED APPLICATIONS

The present application claims the benefit of the earliest available effective filing date and is a divisional application of U.S. patent application Ser. No. 15/618,431 titled “VARIABLE GEOMETRY ROTATING DETONATION COMBUSTOR” having a filing date of Jun. 9, 2017 and which is incorporated herein by reference in its entirety.

### FIELD

The present subject matter relates generally to a system of continuous detonation in a propulsion system.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in either a continuous or pulsed mode. The pulsed mode design involves one or more detonation tubes, whereas the continuous mode is based on a geometry, typically an annulus, within which single or multiple detonation waves spin. For both types of modes, high energy ignition detonates a fuel/air mixture that transitions into a detonation wave (i.e., a fast moving shock wave closely coupled to the reaction zone). The detonation wave travels in a Mach number range greater than the speed of sound (e.g., Mach 4 to 8) with respect to the speed of sound of the reactants. The products of combustion follow the detonation wave at the speed of sound relative to the detonation wave and at significantly elevated pressure. Such combustion products may then exit through a nozzle to produce thrust or rotate a turbine. With various rotating detonation systems, the task of preventing backflow into the lower pressure regions upstream of the rotating detonation has been addressed by providing a steep pressure drop into the combustion chamber. However, such may reduce the efficiency benefits of the rotating detonation combustion system.

Generally, a detonation combustion system is based on whether a minimum quantity of detonation cells can be sustained in an annular combustion chamber. The detonation cell is characterized by a cell width (λ) that depends on the type of fuel and oxidizer as well as the pressure and temperature of the reactants at the combustion chamber and the stoichiometry (ϕ) of the reactants. For each combination of fuel and oxidizer, cell size decreases with increasing pressure and temperature, and for stoichiometry greater than or less than 1.0. In various propulsion system apparatuses, such as for gas turbine engines, the cell width may decrease by 20 times or more from a lowest steady state operating condition (e.g., ground idle) to a highest steady state operating condition (e.g., maximum takeoff).

It is generally known in the art that combustion chamber geometry is defined by a desired detonation cell size based on the fuel-oxidizer mixture and the pressure, temperature, and stoichiometric ratio thereof. Various combinations of fuel-oxidizer mixture, pressure, temperature, and stoichiometric ratio (e.g., at various operating conditions of the propulsion system) may render a fixed geometry combustion chamber inefficient at more than one operating condition.

Therefore, there is a need for a detonation combustion system that provides a desirable detonation cell size across a plurality of operating conditions of the propulsion system.

### BRIEF DESCRIPTION

Aspects and advantages of the invention will be set forth in part in the following description, or may be obvious from the description, or may be learned through practice of the invention.

The present disclosure is directed to a method of operating a propulsion system at an approximately constant detonation cell quantity in the combustion chamber of a detonation combustion system. The propulsion system defines an inlet section upstream of the rotating detonation combustion system and an exhaust section downstream of the rotating detonation combustion system. The method includes providing an outer wall and an inner wall together defining an annular gap and a combustion chamber length extended from a combustion chamber inlet proximate to the fuel-oxidizer mixing nozzle to a combustion chamber exit proximate to the exhaust section of the propulsion system, the annular gap and the combustion chamber length together defining a first volume at a first operating condition defining a lowest steady state pressure and temperature at the rotating detonation combustion system; providing a mixture of a fuel and an oxidizer to the combustion chamber via the fuel-oxidizer mixing nozzle; detonating the fuel and oxidizer mixture in the combustion chamber, wherein the detonation produces a detonation cell size; and adjusting the volume of the combustion chamber via articulating one or more of the outer wall, the inner wall, and the fuel-oxidizer mixing nozzle such that one or more of the annular gap and the combustion chamber length is changed based on one or more operating conditions.

In one embodiment, providing the outer wall and the inner wall defines a maximum annular gap and a maximum combustion chamber length at the first operating condition based on a desired detonation cell size.

In various embodiments, adjusting the volume of the combustion chamber includes actuating one or more of the outer wall and the inner wall along a radial direction. In one embodiment, actuating one or more of the outer wall and the inner wall along the radial direction includes decreasing the annular gap at a second operating condition defining a pressure and temperature at the rotating detonation combustion system greater than the first operating condition.

In still various embodiments, adjusting the volume of the combustion chamber includes actuating the fuel-oxidizer mixing nozzle along a longitudinal direction. In one embodiment, actuating the fuel-oxidizer mixing nozzle along the longitudinal direction decreases the combustion chamber length at a second operating condition defining a pressure and temperature at the rotating detonation combustion system greater than the first operating condition.

In another embodiment, adjusting the volume of the combustion chamber is based at least on maintaining an approximately constant detonation cell quantity at a second operating condition relative to the first operating condition. The second operating condition defines a pressure and temperature at the rotating detonation combustion system greater than the first operating condition.

In other embodiments, the method further includes generating a flow of oxidizer to the fuel-oxidizer mixing nozzle based on a commanded operating condition of the propulsion system; providing a flow of fuel to the fuel-oxidizer mixing nozzle based at least on a commanded operating condition of the propulsion system; and adjusting one or more of a fuel and oxidizer condition based on the commanded operating condition.

In one embodiment, adjusting one or more of a fuel and oxidizer condition based on the commanded operating condition of the propulsion system includes one or more of a fuel flow rate, a fuel pressure, a fuel temperature, an oxidizer flow rate, an oxidizer pressure, and an oxidizer temperature at the rotating detonation combustion system. In another embodiment, the commanded operating condition includes the first operating condition defining a lowest steady state pressure and temperature at the rotating detonation combustion system and a second operating condition defining one or more pressure and temperatures at the rotating detonation combustion system greater than the first operating condition.

In still various embodiments, the method further includes determining a desired volume of the combustion chamber based on one or more of the annular gap and the combustion chamber length at a second operating condition greater than the first operating condition. In one embodiment, determining the desired volume of the combustion chamber includes determining an amount by which one or more of the outer wall and the inner wall articulates along the radial direction. In another embodiment, determining the desired volume of the combustion chamber includes determining an amount by which the fuel-oxidizer mixing nozzle articulates along the longitudinal direction. In still another embodiment, determining the desired volume is based on one or more of a look-up table, a schedule, a transfer function, and one or more performance maps.

In still yet another embodiment, determining the desired volume is based at least on a detonation cell size relative to one or more of a pressure, temperature, and flow rate of the fuel and the oxidizer versus a range of volumes of the combustion chamber corresponding to the desired detonation cell quantity. In one embodiment, the desired detonation cell quantity is approximately equal at the first operating condition and a second operating condition greater than the first operating condition. In another embodiment, the range of volumes comprises a range at which one or more of the outer wall and the inner wall articulates along the radial direction to define a range of annular gaps. In still another embodiment, the range of volumes comprises a fixed combustion chamber length at a second operating condition equal to the first operating condition. In still yet another embodiment, the range of volumes comprises a range at which fuel-oxidizer mixing nozzle articulates along the longitudinal direction to define a range of combustion chamber lengths.

Another embodiment of the method further includes monitoring a detonation stability of the detonated fuel-oxidizer mixture; and determining a desired volume of the combustion chamber based the monitored detonation stability.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a gas turbine engine in accordance with an exemplary embodiment of the present disclosure;

FIG. 2 is cross sectional view of a rotating detonation combustion system in accordance with an exemplary embodiment of the present disclosure;

FIG. 3 is a cross sectional view of the rotating detonation combustion system of FIG. 2 in accordance with an exemplary embodiment of the present disclosure;

FIG. 4 is a cross sectional view of a rotating detonation combustion system in accordance with an exemplary embodiment of the present disclosure;

FIG. 5 is a cross sectional view of the rotating detonation combustion system of FIG. 4 in accordance with an exemplary embodiment of the present disclosure;

FIG. 6 is cross sectional view of a rotating detonation combustion system in accordance with an exemplary embodiment of the present disclosure;

FIG. 7 is a cross sectional view of the rotating detonation combustion system of FIG. 6 in accordance with an exemplary embodiment of the present disclosure;

FIG. 8 is perspective view of a combustion chamber of a rotating detonation combustion system in accordance with an exemplary embodiment of the present disclosure;

FIG. 9 is a cross sectional view of a forward end of a rotating detonation combustion system in accordance with an exemplary embodiment of the present disclosure; and

FIG. 10 is a flowchart including steps of an exemplary embodiment of a method of operating a propulsion system at an approximately constant detonation cell quantity in the combustion chamber of a detonation combustion system.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A propulsion system including a rotating detonation combustion (RDC) system, and method of operation thereof, is generally provided that may produce an approximately constant detonation cell quantity across a plurality of operating conditions of the RDC system and propulsion system. The methods and structures generally provided may produce an approximately constant detonation cell quantity of a fuel-oxidizer detonation within the combustion chamber of the RDC system in a variable volume across a plurality of operating conditions of the propulsion system. In various embodiments, the variable volume is a function of a change in annular gap, in combustion chamber length, or both. The volume of the combustor (i.e., the annulus gap and combustion chamber length) adjusts from a first operating condition (e.g. ground idle) to a second operating condition (e.g. maximum takeoff) to maintain a desired quantity of cells along the combustion chamber length and combustion chamber width (i.e., the annulus gap). For example, as pressure and temperature increase for a fixed operational stoichiometry from the first operating condition to one or more of a second operating condition, the combustion chamber volume adjusts (e.g., decreases) to maintain an approximately constant quantity of cells as the detonation cell size decreases. The structures and methods generally provided herein may improve operability, efficiency, and performance of rotating detonation combustion systems and the propulsion systems, including reduced emissions and fuel consumption, across a plurality of operating conditions of the propulsion system.

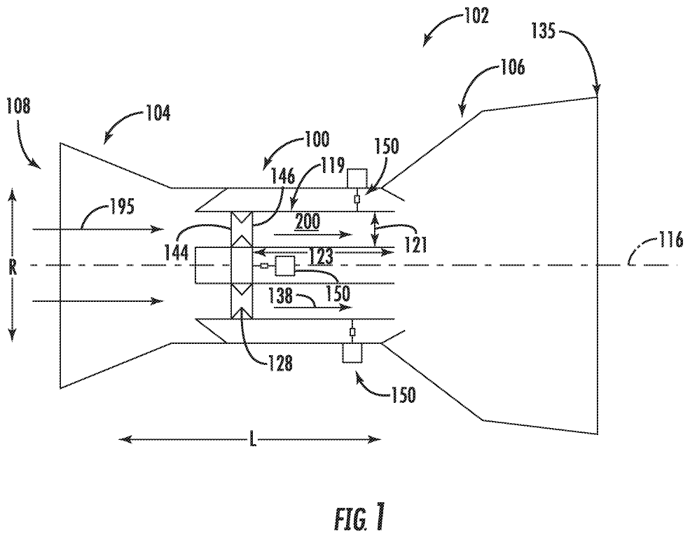

Referring now to the figures, FIG. 1 depicts a propulsion system 102 including a rotating detonation combustion system 100 (an “RDC system”) in accordance with an exemplary embodiment of the present disclosure. The propulsion system 102 generally includes an inlet section 104 and an outlet section 106, with the RDC system 100 located downstream of the inlet section 104 and upstream of the exhaust section 106. In various embodiments, the propulsion system 102 defines a gas turbine engine, a ramjet, or other propulsion system including a fuel-oxidizer burner producing combustion products that provide propulsive thrust or mechanical energy output. In an embodiment of the propulsion system 102 defining a gas turbine engine, the inlet section 104 includes a compressor section defining one or more compressors generating an overall flow of oxidizer 195 to the RDC system 100. The inlet section 104 may generally guide a flow of the oxidizer 195 from an inlet opening 108 through the inlet section 104 to the RDC system 100. The inlet section 104 may further compress the oxidizer 195 before it enters the RDC system 100. The inlet section 104 defining a compressor section may include one or more alternating stages of rotating compressor airfoils. In other embodiments, the inlet section 104 may generally define a decreasing cross sectional area from an upstream end to a downstream end proximate to the RDC system 100.

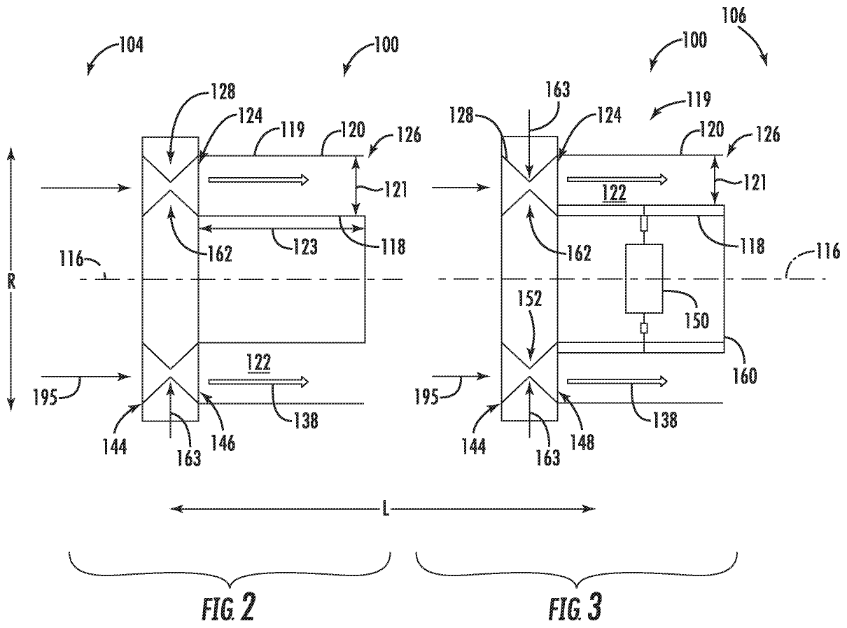

As will be discussed in further detail below, at least a portion of the overall flow of oxidizer 195 is mixed with a fuel 163 (shown in FIG. 2) to generate combustion products 138. The combustion products 138 flow downstream to the exhaust section 106. In various embodiments, the exhaust section 106 may generally define an increasing cross sectional area from an upstream end proximate to the RDC system 100 to a downstream end of the propulsion system 102. Expansion of the combustion products 138 generally provides thrust that propels the apparatus to which the propulsion system 102 is attached, or provides mechanical energy to one or more turbines further coupled to a fan section, a generator, or both. Thus, the exhaust section 106 may further define a turbine section of a gas turbine engine including one or more alternating rows or stages of rotating turbine airfoils. The combustion products 138 may flow from the exhaust section 106 through, e.g., an exhaust nozzle 135 to generate thrust for the propulsion system 102.

As will be appreciated, in various embodiments of the propulsion system 102 defining a gas turbine engine, rotation of the turbine(s) within the exhaust section 106 generated by the combustion products 138 is transferred through one or more shafts or spools to drive the compressor(s) within the inlet section 104. In various embodiments, the inlet section 104 may further define a fan section, such as for a turbofan engine configuration, such as to propel air across a bypass flowpath outside of the RDC system 100 and exhaust section 106.

It will be appreciated that the propulsion system 102 depicted schematically in FIG. 1 is provided by way of example only. In certain exemplary embodiments, the propulsion system 102 may include any suitable number of compressors within the inlet section 104, any suitable number of turbines within the exhaust section 106, and further may include any number of shafts or spools appropriate for mechanically linking the compressor(s), turbine(s), and/or fans. Similarly, in other exemplary embodiments, the propulsion system 102 may include any suitable fan section, with a fan thereof being driven by the exhaust section 106 in any suitable manner. For example, in certain embodiments, the fan may be directly linked to a turbine within the exhaust section 106, or alternatively, may be driven by a turbine within the exhaust section 106 across a reduction gearbox. Additionally, the fan may be a variable pitch fan, a fixed pitch fan, a ducted fan (i.e., the propulsion system 102 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a turboshaft engine, a turboprop engine, a turbojet engine, a ramjet engine, a scramjet engine, etc. Further, in certain embodiments, the RDC system 100 may be incorporated into a non-aeronautical propulsion system, such as a land-based or marine-based power generation system. Further still, in certain embodiments, the RDC system 100 may be incorporated into any other suitable propulsion system, such as a rocket or missile engine. With one or more of the latter embodiments, the propulsion system may not include a compressor in the inlet section 104 or a turbine in the exhaust section 106.

Referring now to FIGS. 2-3, an exemplary embodiment of an RDC system 100 of the propulsion system of FIG. 1 is generally provided. The RDC system 100 generally includes a generally cylindrical walled enclosure 119 defining, at least in part, a combustion chamber 122, a combustion inlet 124, and a combustion outlet 126. The combustion chamber 122 defines an annular combustion chamber length 123 from approximately the combustion inlet 124 to the combustion outlet 126. The combustion chamber 122 further defines a combustion chamber width or annular gap 121 extended from an inner diameter wall to an outer diameter wall. The combustion chamber length 123 and the annular gap 121 together define a combustion chamber volume. In the embodiments generally provided herein, the combustion chamber length 123 and width 121 are each variables for determining the volume of the combustion chamber 122. For example, in various embodiments, the length 123 and width 121 of the combustion chamber 122 is generally sized for a minimum or lowest steady state operating condition of the propulsion system, such as a lowest pressure and temperature of oxidizer in the combustion chamber 122. The lowest steady state operating condition of the propulsion system generally results in a configuration of the RDC system 100 or, more specifically, the combustion chamber 122, at a maximum volume directly related to a detonation cell size of a fuel-oxidizer mixture in the combustion chamber 122. Still more specifically, the lowest steady state operating condition results in a configuration of the combustion chamber 122 at a maximum combustion chamber length 123 and annular gap 121 related to a detonation cell size of fuel-oxidizer mixture in the combustion chamber 122.

In the embodiments generally provided herein, the combustion chamber length 123 and annular gap 121 are each variables for determining the volume of the combustion chamber 122. For example, in various embodiments, the length 123 and annular gap 121 of the combustion chamber 122 is generally sized for a minimum or lowest steady state operating condition of the propulsion system, such as a lowest pressure and temperature of oxidizer in the combustion chamber 122. The lowest steady state operating condition of the propulsion system generally results in a configuration of the RDC system 100 or, more specifically, the combustion chamber 122, at a maximum volume directly related to a detonation cell size of a fuel-oxidizer mixture in the combustion chamber 122.

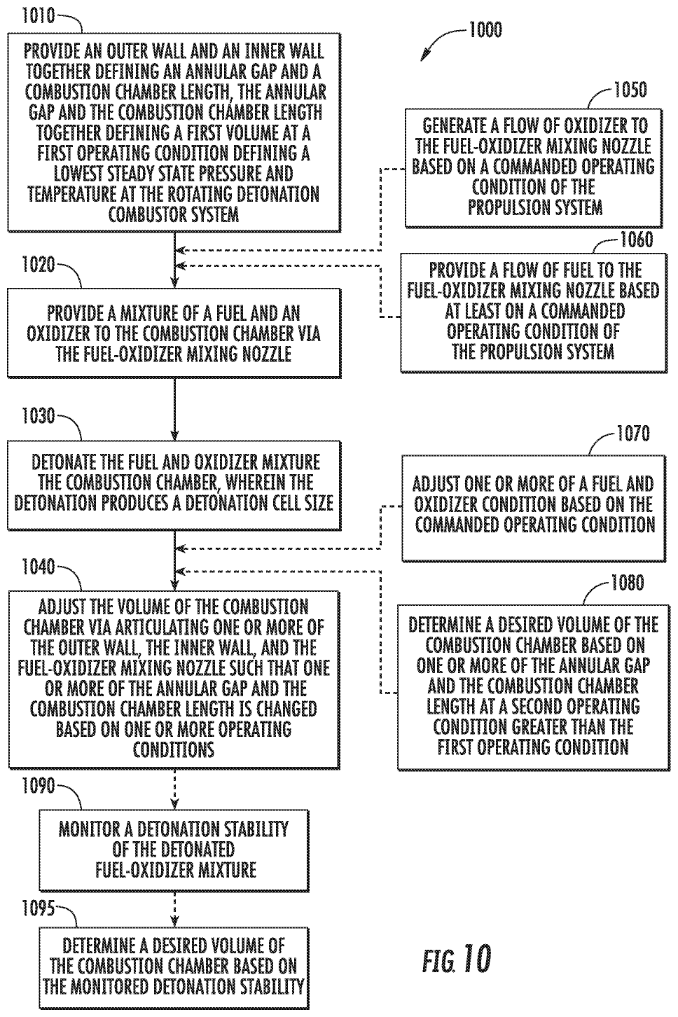

In various embodiments, such as generally provided in cross sectional view of a forward end of the RDC system 100 shown in FIG. 9, the walled enclosure 119 defines a generally annular ring structure including an outer wall 118 and an inner wall 120 spaced from one another along the radial direction R and generally concentric to the longitudinal centerline 116. The outer wall 118 and the inner wall 120 together define in part a combustion chamber 122, a combustion chamber inlet 124, and a combustion chamber outlet 126 (shown in FIGS. 2-5).

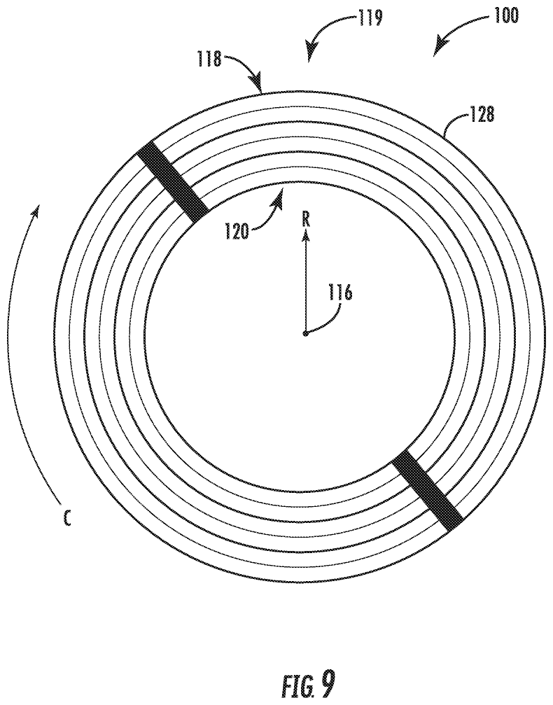

Referring back to FIGS. 2-3, the RDC system 100 further includes a nozzle assembly 128 located at the combustion inlet 124. The nozzle assembly 128 provides a flow mixture of oxidizer and fuel to the combustion chamber 122, wherein such mixture is combusted/detonated to generate the combustion products therein, and more specifically a detonation wave 130 (shown in FIG. 8) as will be explained in greater detail below. The combustion products exit through the combustion chamber outlet 126.

The nozzle assembly 128 is defined at the upstream end of the walled enclosure 119 at the combustion chamber inlet 124. The nozzle assembly 128 generally defines a nozzle inlet 144, a nozzle outlet 146 adjacent to the combustion inlet 124 and combustion chamber 122, and a throat 152 between the nozzle inlet 144 and nozzle outlet 146. A nozzle flowpath 148 is defined from the nozzle inlet 144 through the throat 152 and the nozzle outlet 146. The nozzle flowpath 148 defines in part a primary flowpath 200 through which an oxidizer flows from an upstream end of the propulsion system 102 through to the combustion chamber 122 and to a downstream end of the propulsion system 102. The nozzle assembly 128 generally defines a converging-diverging nozzle, i.e. the nozzle assembly 128 defines a decreasing cross sectional area from approximately the nozzle inlet 144 to approximately the throat 152, and further defines an increasing cross sectional area from approximately the throat 152 to approximately the nozzle outlet 146.

Between the nozzle inlet 144 and the nozzle outlet 146, a fuel injection port 162 is defined in fluid communication with nozzle flowpath 148 or, more generally, the primary flowpath 200 through which the oxidizer flows. The fuel injection port 162 introduces a liquid or gaseous fuel 163, or mixtures thereof, to the flow of oxidizer through the nozzle flowpath 148 and, generally, the primary flowpath 200. In various embodiments, the fuel injection port 162 is disposed at approximately the throat 152 of the nozzle assembly 128. In an embodiment of the RDC system 100 defining a generally annular walled enclosure 119 (e.g., defined by the outer wall 118 and the inner wall 120 as generally provided in FIG. 9) and defining a generally annular combustion chamber 122, a plurality of fuel injection ports 162 are defined in adjacent circumferential arrangement around the longitudinal centerline 116.

Referring still to FIGS. 2-3, in one embodiment, the RDC system 100 includes an actuation structure 150 disposed within a centerbody 160. The centerbody 160 is generally defined by the inner wall 118 of the walled enclosure 119. The actuation structure 150 is coupled to the inner wall 118 of the walled enclosure 119 to articulate the inner wall 118 so as to adjust or vary its radius. For example, the actuation structure 150 may be coupled to a plurality of overlapping walls defining the inner wall 118 of the walled enclosure 119. The actuation structure 150 expands or contracts the inner wall 118 so as to adjust or vary the annular gap 121 of the combustion chamber 122. The actuation structure 150 is configured to articulate the inner wall 118 generally along the radial direction R based at least on one or more operating conditions of the propulsion system 102, and changes thereof. The actuation structure 150 may therefore alter, such as increase or decrease, the volume of the combustion chamber 122 based on the annular gap 121.

The actuation structure 150 may generally include a hydraulic or pneumatic actuator. In one embodiment, the actuation structure 150 includes a hydraulic fluid, a lube, or liquid fuel, providing a motive force or pressure to articulate the actuation structure 150. In still various embodiments, the actuation structure 150 may be configured at least partially of a fuel system providing fuel 163 to the RDC system 100.

In other embodiments, the actuation structure 150 includes a pneumatic fluid, such as air, an inert gas, or gaseous fuel providing a motive force or pressure to articulate the actuation structure 150. For example, the pneumatic fluid may include air from the inlet section 104 to articulate the actuation structure 150. As another example, the pneumatic fluid may include fuel 163 defining a gaseous fuel further configured in conjunction with the nozzle assembly 128.

In still other embodiments, the actuation structure 150 includes one or more springs or spring-loaded assemblies configured to react against the outer wall 120, the inner wall 118, and/or the nozzle assembly 128 based at least on a plurality of operating conditions of the propulsion system 102. For example, the actuation structure 150 defining a spring assembly may configure the spring based at least on a pressure exerted against one or more of the outer wall 120, the inner wall 118, and the nozzle assembly 128 within the combustion chamber 122. As another example, the actuation structure 150 defines a spring assembly defining a spring constant based on a plurality of operating conditions inducing a plurality of pressures against which the actuation structure 150 defining a spring assembly reacts.

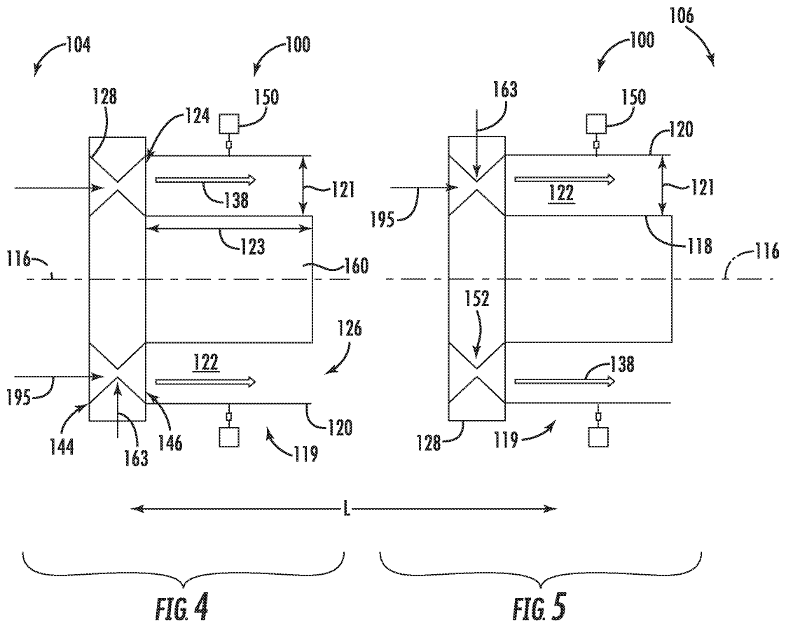

Referring now to FIGS. 4-5, the RDC system 100 generally provided may be configured substantially similarly as described in regard to FIGS. 1-3, including structures and reference numbers not presently shown in FIGS. 4-5. However, in FIGS. 4-5, the actuation structure 150 is coupled to the outer wall 120 of the walled enclosure 199 to articulate the outer wall 120 so as to adjust or vary its radius. For example, the actuation structure 150 may be coupled to a plurality of overlapping walls defining the outer wall 120 of the walled enclosure 119. The actuation structure 150 expands or contracts the outer wall 120 so as to adjust or vary the annular gap 121 of the combustion chamber 122. The actuation structure 150 is configured to articulate the outer wall 120 generally along the radial direction R based at least on one or more operating conditions of the propulsion system 102, and changes thereof. Referring to FIGS. 1-5 collectively, the actuation structure 150 may therefore alter, such as increase or decrease, the volume of the combustion chamber 122 based on the annular gap 121 by articulating the inner wall 118, the outer wall 120, or both along the radial direction R.

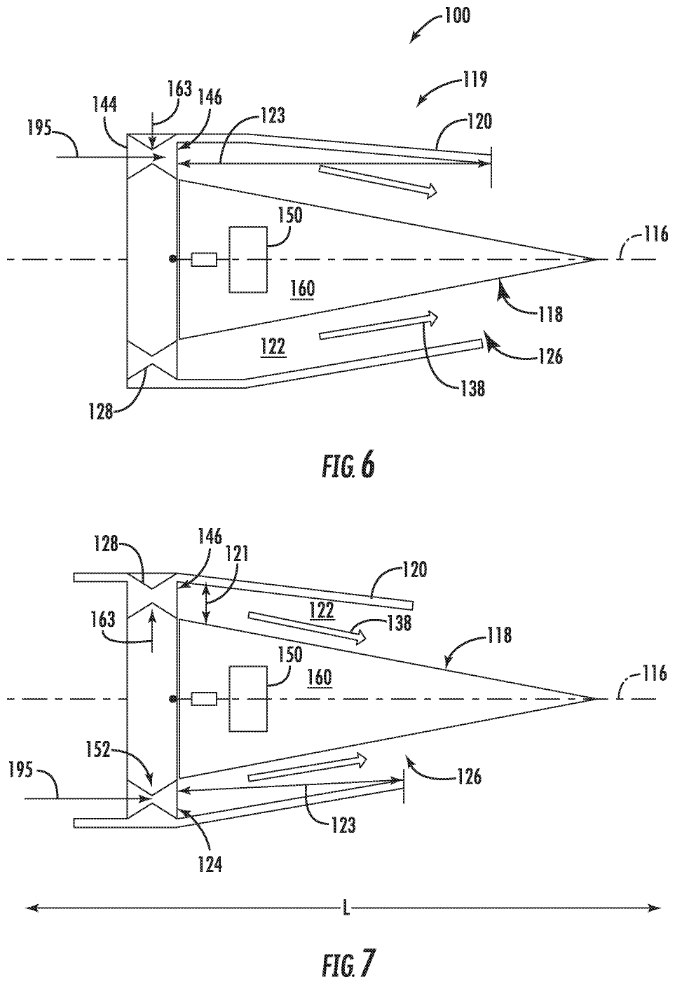

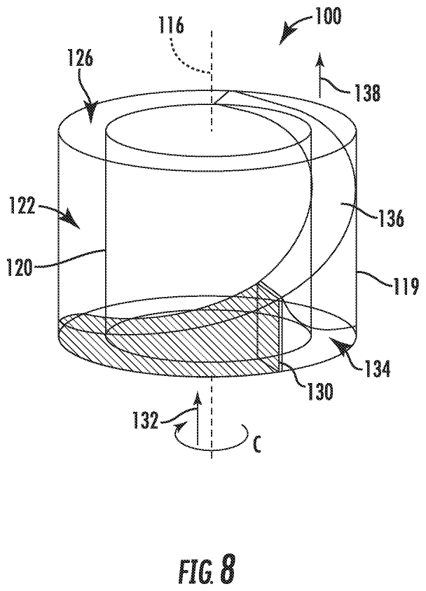

Referring now to FIGS. 6-7, the RDC system 100 generally provided may be configured substantially similarly as described in regard to FIGS. 1-5, including structures and reference numbers not presently shown in FIGS. 6-7. In FIGS. 6-7, the actuation structure 150 is coupled to the nozzle assembly 128 to articulate the nozzle assembly 128 so as to adjust or vary the combustion chamber length 123. For example, the actuation structure may be coupled within the centerbody 160 and to the nozzle assembly 128. The actuation structure 150 expands or contracts to articulate or displace the nozzle assembly 128 along the longitudinal direction L. As such, the actuation structure 150 may alter, such as decrease or increase, the volume of the combustion chamber 122 based on the combustion chamber length 123.

In one embodiment, such as shown in FIGS. 6-7, the centerbody 160, including the inner wall 118, may define a taper in which the cross sectional area decreases from the upstream end to the downstream end of the combustion chamber 122. The outer wall 120 may further define a taper in which the outer wall 120 is generally parallel to the inner wall 118. In various embodiments, the centerbody defines a conical or frusto-conical structure.

Referring briefly to FIG. 8, providing a perspective view of the combustion chamber 122 (without the nozzle assembly 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., combustion products) exits the combustion chamber 122 and is exhausted.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the combustion contributes to the propagation of the detonation shockwave 130. Further, with continuous detonation, the detonation wave 130 propagates around the combustion chamber 122 in a continuous manner, operating at a relatively high frequency. Additionally, the detonation wave 130 may be such that an average pressure inside the combustion chamber 122 is higher than an average pressure within typical combustion systems (i.e., deflagration combustion systems). Accordingly, the region 134 behind the detonation wave 130 has very high pressures.

The propulsion system 102 and RDC system 100 shown and described in regard to FIGS. 1-9 may be generally utilized in a method of operating a rotating detonation combustion system for a propulsion system (hereinafter, “method 1000”). The propulsion system in which the method 1000 may be implemented includes a rotating detonation combustion system (e.g., RDC system 100) including a combustion chamber (e.g., combustion chamber 122) and a fuel-oxidizer mixing nozzle (e.g., nozzle assembly 128), an inlet section (e.g., inlet section 104) upstream of the RDC system, and an exhaust section (e.g., exhaust section 106) downstream of the RDC system. As previously mentioned, in various embodiments, the propulsion system may define a compressor section in the inlet section and a turbine section in the exhaust section.

The method 1000 generally includes at 1010 providing an outer wall and an inner wall together defining an annular gap and a combustion chamber length extended from a combustion chamber inlet proximate to the fuel-oxidizer mixing nozzle to a combustion chamber exit proximate to the exhaust section of the propulsion system, the annular gap and the combustion chamber length together defining a first volume at a first operating condition defining a lowest steady state pressure and temperature at the rotating detonation combustor system; at 1020 providing a mixture of a fuel and an oxidizer to the combustion chamber via the fuel-oxidizer mixing nozzle; at 1030 detonating the fuel and oxidizer mixture in the combustion chamber, wherein the detonation produces a detonation cell size; and at 1040 adjusting the volume of the combustion chamber via articulating one or more of the outer wall, the inner wall, and the fuel-oxidizer mixing nozzle such that one or more of the annular gap and the combustion chamber length is changed based on one or more operating conditions.

FIG. 10 depicts steps performed in a particular order for purposes of illustration and discussion. Those of ordinary skill in the art, using the disclosures provided herein, will understand that the various steps of any of the methods disclosed herein can be modified, adapted, expanded, rearranged and/or omitted in various ways without deviating from the scope of the present disclosure.

In one embodiment at 1010, providing the outer wall and the inner wall defining a maximum annular gap and a maximum combustion chamber length at the first operating condition based on a desired detonation cell size. In various embodiments, the first operating condition is a lowest steady state pressure and temperature at the rotating detonation combustion system. For example, the first operating condition may be a lowest pressure and temperature at the RDC system 100 following startup or ignition of the propulsion system 102. In embodiments defining a gas turbine engine, the first operating condition may define a ground idle condition.

Generally, the desired detonation cell size is determined based at least on a desired performance or operability of the RDC system. Determining the desired detonation cell size may then generally determine the annular gap (e.g., annular gap 121) and the combustion chamber length (e.g., combustion chamber length 123), together of which defines the volume of the combustion chamber (e.g., combustion chamber 122). Determining the desired detonation cell size based on the first operating condition may generally determine a maximum volume of the combustion chamber based on the annular gap and the combustion chamber length. As such, the outer wall 120 is disposed to a maximum radius relative to the first operating condition, in which the radius may decrease relative to a second operating condition defining a pressure and temperature greater than the first operating condition. The inner wall 118 is disposed to a minimum radius relative to the first operating condition, in which the radius may increase relative to the second operating condition. Adjusting the outer wall 120 at a maximum radius, the inner wall 118 at a minimum radius, or both may define a maximum annular gap of the combustion chamber 122 at the first operating condition.

In various embodiments, the second operating condition defines a maximum pressure and temperature at the RDC system. For example, in embodiments of the propulsion system 102 defining a gas turbine engine, the second operating condition includes a maximum take-off condition. In other embodiments, the second operating condition includes one or more steady state operating conditions greater than the first operating condition (e.g., greater than ground idle), including those defining pressure and temperature at the RDC system less than maximum (e.g., climb, flight idle, cruise, approach, landing, etc.). In still various embodiments, the second operating condition defines a full-load or part-load condition.

Referring to the step at 1020 and 1030, providing the mixture of fuel and oxidizer to the fuel-oxidizer mixing nozzle and detonating the mixture at the combustion chamber may be performed as generally provided and described in regard to FIGS. 1-9. For example, the fuel 163 enters through the nozzle assembly 128 and mixes with the oxidizer 195 flowing through the nozzle flowpath 148 toward the combustion chamber 122. The fuel-oxidizer mixture is detonated in the combustion chamber 122 to produce combustion products 138. The combustion products 138 flow downstream toward and through the exhaust section 106, generally providing thrust or energy to the propulsion system 102 or any apparatus attached thereto (e.g., land, sea, air, or space-based vehicles, power turbines, generators, etc.).

In one embodiment at 1040, adjusting the volume of the combustion chamber includes actuating one or more of the outer wall and the inner wall along a radial direction. For example, referring to FIGS. 1-5, actuating the outer wall 120, the inner wall 118, or both via actuation structure 150 generally adjusts the volume of the combustion chamber 122 by changing the annular gap 121 as generally described herein. In various embodiments as further described herein, actuating the outer wall 120, the inner wall 118, or both along the radial direction R includes decreasing the annular gap 121 at the second operating condition defining a steady state pressure and temperature at the rotating detonation combustion system greater than the first operating condition.

In another embodiment at 1040, adjusting the volume of the combustion chamber includes actuating the fuel-oxidizer mixing nozzle along a longitudinal direction L. For example, as shown in FIGS. 6-7, actuating the nozzle assembly 128 generally adjusts the volume of the combustion chamber 122. More specifically, actuating the nozzle assembly 128, such as through one or more actuation structures 150, adjusts the volume of the combustion chamber 122 by changing the combustion chamber length 123. In various embodiments, actuating the nozzle assembly 128, defining the fuel-oxidizer mixing nozzle, along the longitudinal direction L decreases the combustion chamber length 123 at the second operating condition.

In yet another embodiment of the method 1000 at 1040, adjusting the volume of the combustion chamber is based at least on maintaining an approximately constant detonation cell quantity at a second operating condition relative to the first operating condition. For example, as the annular gap 121 and the combustion chamber length 123 define the volume of the combustion chamber 122, the annular gap 121 and the combustion chamber length 123 are defined by a desired detonation cell size, of which is a function of pressure, temperature, and flow of the fuel 163 and oxidizer 195 detonated in the combustion chamber 122. Therefore, the volume of the combustion chamber 122 is adjusted via changes in the annular gap 121, the combustion chamber length 123, or both, based at least on maintaining an approximately constant detonation cell quantity as one or more of the pressure, temperature, and flow of the fuel 163 and oxidizer 195 change based on changes on the operating condition from the first operating condition to the second operating condition. The annular gap 121, the combustion chamber length 123, or both are each adjusted from the first operating condition to the one or more second operating conditions to maintain a desired quantity of cells along the combustion chamber length 123, the annular gap 121 (e.g., width), or both. For example, as pressure and temperature increase for a fixed operational stoichiometry from the first operating condition to the one or more second operating conditions, the cell size may remain generally constant as the volume defined by the annular gap 121 and the combustion chamber length 123 is decreased to effectively maintain an approximately constant quantity of cells in the combustion chamber 122 along the width (e.g., annular gap 121) and the combustion chamber length 123.

The method 1000 may further include at 1050 generating a flow of oxidizer to the fuel-oxidizer mixing nozzle based on a commanded operating condition of the propulsion system; at 1060 providing a flow of fuel to the fuel-oxidizer mixing nozzle based at least on a commanded operating condition of the propulsion system; and at 1070 adjusting one or more of a fuel and oxidizer condition based on the commanded operating condition.

In various embodiments at 1050, generating a flow of oxidizer to the fuel-oxidizer mixing nozzle (e.g., the nozzle assembly 128) may include pressurizing the oxidizer through an inlet section 104 defining a compressor section of a gas turbine engine. In other embodiments, generating a flow of oxidizer to the fuel-oxidizer mixing nozzle includes ram air through the inlet section 104 or flowing a pressurized oxidizer to the RDC system 100.

In still various embodiments at 1060, providing a flow of fuel to the fuel-oxidizer mixing nozzle based at least a commanded operating condition of the propulsion system may include a throttle lever angle or power lever angle (PLA). The commanded operating condition may include correlating the PLA to a desired engine output such as thrust output, power output, rotor speed (e.g., low rotor speed N1, fan rotor speed N_{fan}, etc.), or engine pressure ratio (EPR). In still various embodiments at 1060 and 1070, one or more computing devices (e.g., a controller, such as an electronic engine control (EEC), engine control unit (ECU), or, more specifically, a full authority digital engine control (FADEC)) may store tables, curves, look-up charts, equations, transfer functions, etc. to correlate the PLA to the desired engine output and further provide to the propulsion system 102 one or more of a commanded parameter including fuel flow rate, fuel pressure, fuel temperature, high rotor speed (e.g., N2 or N_{H}), intermediate rotor speed (e.g., N_{I}), oxidizer flow rate, oxidizer pressure, and oxidizer temperature, including one or more of a bleed valve angle, variable stator vane, or variable guide vane angle. As such, adjusting one or more of a fuel and oxidizer condition includes adjusting or modulating one or more of the aforementioned parameters. In still various embodiments, adjusting or modulating the fuel and oxidizer condition may be based more specifically on the condition at the RDC system 100.

The various commanded operating conditions of the propulsion system (e.g., propulsion system 102) includes the first operating condition defining a lowest pressure and temperature at the rotating detonation combustion system and a second operating condition defining one or more pressure and temperatures at the rotating detonation combustion system greater than the first operating condition. As previously stated, the first operating condition may generally define an idle or ground idle condition of the propulsion system. The second operating condition may generally define a plurality of conditions greater than idle, including a maximum take-off condition generally defining a maximum pressure and temperature condition at the RDC system 100, as well as a plurality of operating conditions between idle and maximum take-off.

The method 1000 may further include at 1080 determining a desired volume of the combustion chamber based on one or more of the annular gap and the combustion chamber length at a second operating condition greater than the first operating condition. Determining the desired volume of the combustion chamber may include determining, via a controller such as described above, the annular gap 121, the combustion chamber length 123, or both at a plurality of operating conditions great than the first operating condition.

In one embodiment at 1080, and in conjunction with FIGS. 1-9, determining the desired volume of the combustion chamber 122 includes determining an amount by which one or more of the outer wall 120 and the inner wall 118 articulates along the radial direction R via the actuating structure 150. In another embodiment, determining the desired volume of the combustion chamber 122 includes determining an amount by which the fuel-oxidizer mixing nozzle (e.g., the nozzle assembly 128) articulates along the longitudinal direction L via the actuating structure 150.

In various embodiments, determining the desired volume is based on one or more of a look-up table, a schedule, one or more equations, a transfer function, one or more performance maps, or combinations thereof. Determining the desired volume is based at least on a detonation cell size relative to one or more of a pressure, temperature, and flow rate of the fuel and the oxidizer versus a range of volumes of the combustion chamber corresponding to the desired detonation cell quantity. The desired detonation cell quantity is approximately equal at the first operating condition and a second operating condition greater than the first operating condition.

In one embodiment, the range of volumes includes a range at which one or more of the outer wall 120 and the inner wall 118 articulates along the radial direction R to define a range of annular gaps 121. In various embodiments, the range of volumes includes a fixed combustion chamber length 123. For example, the combustion chamber length 123 may be constant or fixed at one or more of the second operating condition relative to the first operating condition.

In another embodiment, the range of volumes includes a range at which fuel-oxidizer mixing nozzle (e.g., the nozzle assembly 128) articulates along the longitudinal direction L to define a range of combustion chamber lengths 123. In still various embodiments, the range of volumes includes a fixed annular gap 121 that is generally constant or fixed at one or more of the second operating condition relative to the first operating condition.

In still various embodiments, the method 1000 may further include at 1090 monitoring a detonation stability of the detonated fuel-oxidizer mixture; and at 1095 determining a desired volume of the combustion chamber based the monitored detonation stability. For example, referring to FIGS. 1-9, monitoring the detonation stability may include monitoring a pressure value at or downstream of the combustion chamber 122 of the detonated fuel-oxidizer mixture 138. Monitoring the pressure may include utilizing a pressure probe, or more specifically, a dynamic pressure probe, proximate to or downstream of the combustion chamber 122. Monitoring the pressure may include monitoring a peak-to-peak value of pressure values over time and establishing one or more limits or thresholds. Determining a desired volume based on the monitored detonation stability may include utilizing a computing device to determine a change in annular gap 121, the combustion chamber length 123, or both based on one or more pressure values over a period of time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A propulsion system defining a longitudinal centerline extended along a longitudinal direction, the propulsion system comprising:
an inlet section configured to provide an oxidizer to a rotating detonation combustion system positioned downstream of the inlet section; and
wherein the rotating detonation combustion system comprises;
a nozzle assembly positioned to provide a flow mixture of oxidizer and fuel to a combustion chamber;
a centerbody forming an inner wall of the combustion chamber;
an outer wall at least partially surrounding the centerbody, wherein the inner wall and the outer wall define a volume of the combustion chamber; and
an actuation structure coupled to the nozzle assembly, wherein the actuation structure is configured to expand and contract to displace the nozzle assembly along the longitudinal direction to alter the volume of the combustion chamber.

2. The propulsion system of claim 1, wherein the centerbody is conical or frusto-conical.

3. The propulsion system of claim 2, wherein the outer wall provides a taper, wherein the taper at the outer wall decreases a cross sectional area of the combustion chamber from an upstream end to a downstream end.

4. The propulsion system of claim 3, wherein the nozzle assembly comprises:
a nozzle inlet;
a nozzle outlet;
a throat positioned between the nozzle inlet and the nozzle outlet, wherein a converging-diverging nozzle is defined between the nozzle inlet and the nozzle outlet; and
a fuel injection port positioned within a nozzle flowpath between the nozzle inlet and the nozzle outlet.

5. The propulsion system of claim 4, wherein the fuel injection port is positioned approximately at the throat of the nozzle assembly.

6. The propulsion system of claim 1, wherein the actuation system is positioned at the centerbody.

7. The propulsion system of claim 1, wherein the centerbody is conical or frusto-conical, and wherein an annular gap is defined between the inner wall and the outer wall.

8. The propulsion system of claim 7, wherein the actuation system is configured to increase or decrease the volume of the combustion chamber based on the annular gap.

9. The propulsion system of claim 1, wherein the actuation system comprises a spring assembly configured to react against the nozzle assembly based on a plurality of operating conditions of the propulsion system.

10. The propulsion system of claim 1, wherein the actuation structure is configured to expand and contract to displace the nozzle assembly along the longitudinal direction to alter a combustion chamber length of the combustion chamber.

11. A rotating detonation combustion system, the system comprising:
a nozzle assembly positioned to provide a flow mixture of oxidizer and fuel to a combustion chamber;
a centerbody forming an inner wall of the combustion chamber;
an outer wall at least partially surrounding the centerbody, wherein the inner wall and the outer wall define a volume of the combustion chamber; and
an actuation structure coupled to the nozzle assembly, wherein the actuation structure is configured to expand and contract to displace the nozzle assembly along a longitudinal direction to alter the volume of the combustion chamber.

12. The system of claim 11, wherein the centerbody is conical or frusto-conical.

13. The system of claim 12, wherein the outer wall provides a taper, wherein the taper at the outer wall decreases a cross sectional area of the combustion chamber from an upstream end to a downstream end.

14. The system of claim 13, wherein the nozzle assembly comprises:
a nozzle inlet;
a nozzle outlet;
a throat positioned between the nozzle inlet and the nozzle outlet, wherein a converging-diverging nozzle is defined between the nozzle inlet and the nozzle outlet; and
a fuel injection port positioned within a nozzle flowpath between the nozzle inlet and the nozzle outlet.

15. The system of claim 14, wherein the fuel injection port is positioned approximately at the throat of the nozzle assembly.

16. The system of claim 11, wherein the actuation system is coupled to the centerbody.

17. The system of claim 1, wherein the centerbody is conical or frusto-conical, and wherein an annular gap is defined between the inner wall and the outer wall.

18. The system of claim 17, wherein the actuation system is configured to increase or decrease the volume of the combustion chamber based on the annular gap.

19. The system of claim 11, wherein the actuation system comprises a spring assembly configured to react against the nozzle assembly based on a plurality of operating conditions of the propulsion system.

20. The system of claim 11, wherein the actuation structure is configured to expand and contract to displace the nozzle assembly along the longitudinal direction to alter a combustion chamber length of the combustion chamber.
